(19) United States
(12) Patent Application Publication
(10) Pub. No.: US 2014/0059455 A1
(43) Pub. Date: Feb. 27, 2014

(54) SYSTEM AND METHOD FOR EFFICIENTLY SELECTING DATA ENTITIES REPRESENTED IN A GRAPHICAL USER INTERFACE

(71) Applicants: Rolan Abdukalykov, Montreal (CA); Edward Palmer, Westmount (CA); Roy Ghorayeb, Montreal (CA); Mohannad El-Jayousi, L'lle-Bizard (CA); Vincent Lavoie, Montreal (CA); Xuebo Liang, Brossard (CA); Alain Gauthier, Montreal (CA)

(72) Inventors: Rolan Abdukalykov, Montreal (CA); Edward Palmer, Westmount (CA); Roy Ghorayeb, Montreal (CA); Mohannad El-Jayousi, L'lle-Bizard (CA); Vincent Lavoie, Montreal (CA); Xuebo Liang, Brossard (CA); Alain Gauthier, Montreal (CA)

(73) Assignee: SAP AG, Walldorf (DE)

(21) Appl. No.: 13/592,139

(22) Filed: Aug. 22, 2012

(51) Int. Cl. G06F 3/048

(52) U.S. Cl. 715/764

(57) ABSTRACT

A system, method, and computer program product for selecting single or multiple data entities, based on selection of representative items in a graphical user interface via a user input gestural trajectory. Embodiments display items representing data entities, some of which may be selected by a user for further processing by crossing or surrounding the items with a pointing device, such as a mouse, or stylus or fingertip via a touchscreen device. Selected items are visually highlighted in the interface, and the data entities they represent are added to a cache table depicted in a separate summary box. The box includes controls for fast and efficient data entity selection and deselection, display of related criteria, as well as data entity approval and disapproval, and editing capability.

### BACKGROUND

The present invention relates to selecting data entities represented by items in a graphical user interface, and in particular to selecting multiple data entities with gestures on a display device to control their subsequent processing.

Many instances may arise in which a user of a computing device wishes to rapidly view and make choices among a group of items depicted in a graphical user interface that represent various data entities. Data entities may comprise specific database entries, project tasks, documents, rebates for a promotional campaign, components used for an assembly, and business transactions for example. Some of the data entries may be selected for further processing.

The user may wish to view available detailed information that is related to the data entities, view which data entities have been previously selected, and/or make new entity selections or deselections. For example, software applications for approving expenses may depict different data entities along a time dimension via displayed graphical tokens. Likewise, a user may wish to efficiently select particular portions of a large set of data entities in an enterprise resource planning application. The subsequent processing may include any tasks that are required as part of business activities.

Displaying an entire dataset may not always be an option. In some instances the dataset is simply too large to allow for convenient display. For example, a display device may be of limited size and resolution, which is often the case with mobile computing devices such as personal digital assistants (PDAs) and smartphones. The user may therefore pan the display to view different portions of the dataset, e.g. in a calendar scenario the user may move along a timeline to display items corresponding to different date ranges. Data entities may be identified by a particular identifying text string or number for compact display.

Unfortunately, past data entity selection tools often required a user to select items only one at a time, which is inconvenient and inefficient. Users want to avoid touching or otherwise selecting many separate entities, as this slows down the selection process. Further, for large datasets with scattered selected entities, it is often difficult for a user to get a complete picture of the selections that have been made. This may prevent the user from easily maintaining context when navigating within a dataset of significant breadth or depth.

### BRIEF DESCRIPTION OF THE DRAWINGS

FIG. 1 is a diagram of an exemplary display of items representing data entities for different projects in a calendar format with an approval status summary box, according to an exemplary embodiment.

FIG. 2 is a diagram of an exemplary display of items representing data entities in a calendar format with an approval status summary box, according to an exemplary embodiment.

FIG. 3 is a diagram of an exemplary display of items representing data entities in a rectangular multi-row selection calendar format, according to an exemplary embodiment.

FIG. 4 is a diagram of an exemplary display of items representing data entities in a calendar format with a boundary based selection, according to an exemplary embodiment.

FIG. 5 is a diagram of an exemplary display of items representing data entities in a calendar format with an approval status summary box, according to an exemplary embodiment.

FIG. 6 is a diagram of an exemplary computer system to implement various embodiments.

FIG. 7 is a flowchart of an exemplary method of performing the data entity selection.

### DETAILED DESCRIPTION

As described more fully below, the embodiments disclosed permit improved selection of data entities represented by items in a graphical user interface. Embodiments provide control algorithms to manage a display and user interface within a computer system such as, for example, a mobile computing device. The user interface may display a set of items along with various approval status summary boxes to help a user retain selection context. User gestures and other interactions may control mass selection of represented data entities.

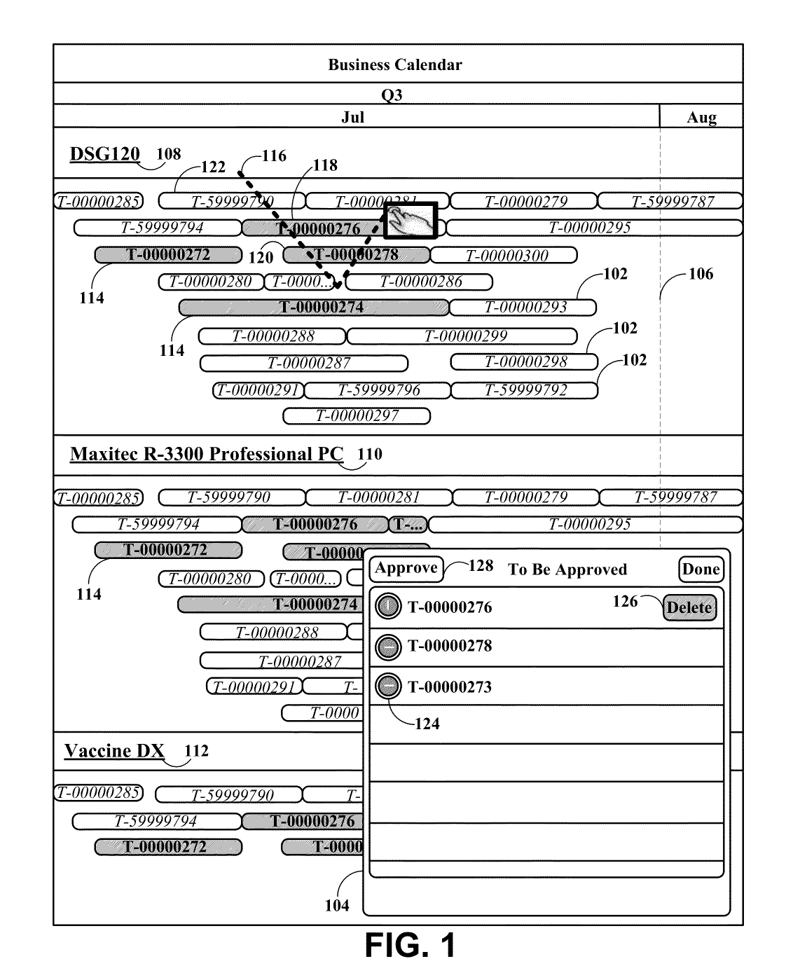

Referring now to FIG. 1, a diagram is shown of an exemplary display of items 102 representing data entities for different projects in a calendar format with an approval status summary box 104. A user may view such a display to select particular data entities to be subjected to further processing. In this example, data for the third quarter of a given year is shown, with July and part of August depicted along with a dashed dividing line 106.

Different projects may be displayed simultaneously, e.g., the “DSG120” 108, “Maxitec R-3300 Professional PC” 110, and “Vaccine DX” 112 exemplary projects are depicted in different vertically separated display regions. Note, although the display regions shown here are each for different projects, it is also possible to display different product groups or categories, or business entities, or entire trade promotions in the same manner. A trade promotion or ad campaign may encompass many companies, product lines, and individual products, so the display shown is merely exemplary. Data entities for each project are depicted by graphical user interface items 102, in this case rounded containers. The items as shown each include an identifier string.

The user interface visually informs users of the selection status of each data entity represented. In this application, unselected items 102 are shown unshaded with italic font used for the identifier string, while selected items 114 are shown shaded with bold non-italic font for the identifier string, but this depiction is merely exemplary. Any item visual distinction attribute may be used, including font, font size, font color, item shading, boundary line thickness, item colors, blinking, scrolling text, and other graphic and/or animation effects as may be known in the art. Items may be compressed in display size for user convenience, and the identifying string may be replaced with an abbreviation, e.g. “T- . . . ” or “T-0000 . . . ” as shown in this figure.

In the past, a user selected individual items in the display by designating an item separately and then indicating that its status should be changed from unselected to selected. Users typically designated items by touching them with a cursor controlled by a tactile device like a mouse or trackball, or by moving a cursor over a particular item. With the advent of touchscreen devices, users may instead employ a stylus or finger to designate a particular item. A mouse click or a double-tap or other interaction with a stylus or finger or other tactile device is often used to indicate the user's intent to select the designated item. If a designated item has already been selected, repetition of the selection action may serve to deselect it, or more generally to toggle the selection status. The meaning of repeated selection actions may be set by a user-controllable option.

Individual item selection may however prove inconvenient and time-consuming for users when there is a large number of items. Further, a particular data entity may be represented by more than one instance of a particular item in a graphical user interface, sometimes across several groups on the screen. This may occur, for example, if a particular component is used in the assembly of different products, or if a particular task is performed multiple times in a project. Users should not have to select the same data entity that appears in multiple representative items. Instead, they should be able to select a data entity from one group and have it automatically selected in other groups if they wish.

Embodiments therefore enable a user to select multiple items representing potentially multiple data entities to be selected at one time. A user may select multiple items in a graphical user interface according to the trajectory of a pointing device, including for example a cursor controlled by a mouse, stylus, or finger. Users may select a single data entity or multiple entities by continuously panning or touching or intersecting or surrounding or otherwise interacting with the display area where representative items are located. The embodiments detect the positions of each touch or pan or other interaction, and compare these against the positions of the representative items that are displayed on the screen.

One example trajectory to denote items to be approved is a “check mark” trajectory 116 as shown in this figure. Using a finger for example, a user may touch the display in a blank area and then traverse at least one item in the display in a downward direction, then change the direction of traversal to upward. The check mark 116 interaction formed, shown via a dashed line in this figure (which may actually be depicted in the display as a temporary path marker), may both designate and select all items that are crossed on both the downward and the upward portions of the trajectory. In this instance, items labeled T-00000276 and T-00000278 (items 118 and 120) are crossed both downwardly and upwardly by the user's finger as shown, and are therefore selected. The item labeled T-59999790 (item 122) is not selected, as it was traversed only in the downward direction. The check mark trajectory may be applied to select a single item or to select multiple items in a user-intuitive manner. Users may also set options to define how various trajectories operate, e.g. in this instance either a downward or an upward trajectory interaction may be accepted, instead of both being required. Also, even if a particular defined trajectory is observed, items within its scope may not all necessarily be selected, for example if particular eligibility criteria specified are not met by an item.

FIG. 1 also depicts an approval status summary box 104 that collects information about items recently selected by a user, and whether they are to be approved, either individually or as a group. For example, the item labeled T-00000276 is listed in a short table with items labeled T-00000278 and T-00000273. These items may be those selected by a user through single item selection, and/or a trajectory-based item selection as described. The embodiments include an efficient cache table that records all the selected data entities, with a single entry for each.

After the selection is done, the user is given a choice of managing the selected data entities list in order to finalize the approval process. For example, a user may touch or otherwise interactively select status indicators 124 for each item in the approval status summary box 104 to approve them immediately. Such an approval may trigger the highlighting or other visual indication of approval of all the items representing the same data entity, even if they are in different groups or projects. A “delete” button 126 may be present for each item in the approval status summary box that has not yet been marked for approval to be removed directly via the approval status summary box. Likewise, an “approve” button 128 may be selected by a user to immediately approve all the items listed in the approval status summary box 104. By aggregating selected items into the approval status summary box 104, user context is more easily maintained, particularly when selected items may span different projects or different regions of a calendar not easily seen simultaneously in the display.

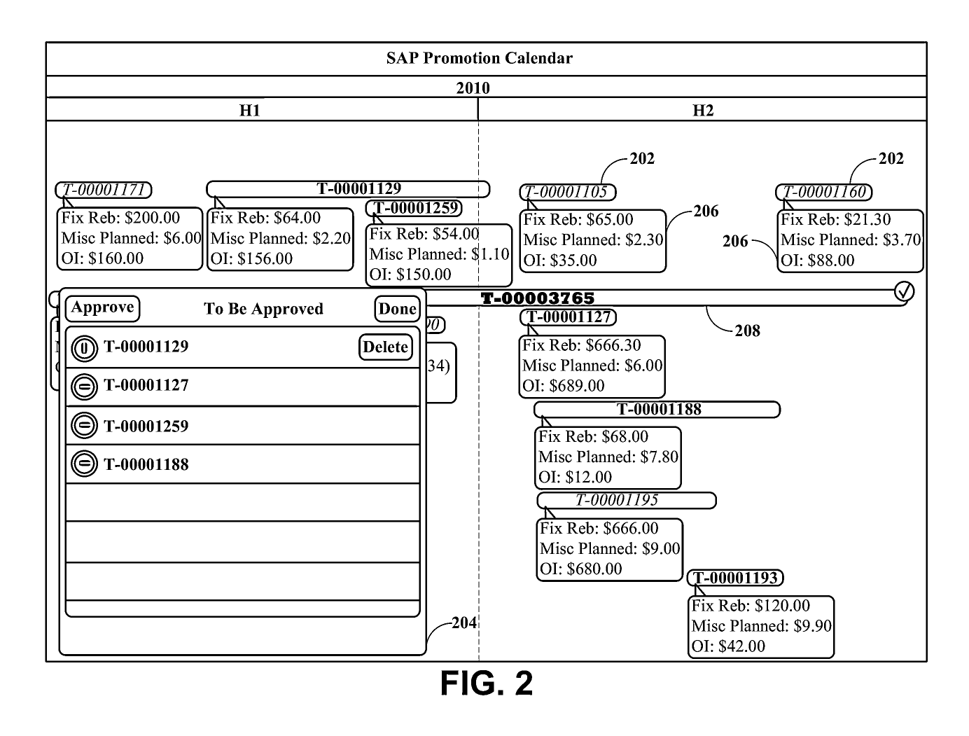

Referring now to FIG. 2, a diagram is shown of another exemplary display of items 202 representing data entities in a calendar format with an approval status summary box 204. This display shows items for the first and second halves of the year 2010, and also shows summary data 206 for each item below the item. The user may enable the display of summary data for some or all of the items being displayed, which may help the user determine which items to select. In this application, approved item labeled T-00003765 (item 208) is shown in a darker shade and in a thicker non-italic bold font to denote that it has already been approved, but any method of visually differentiating the approval status of an item may be used.

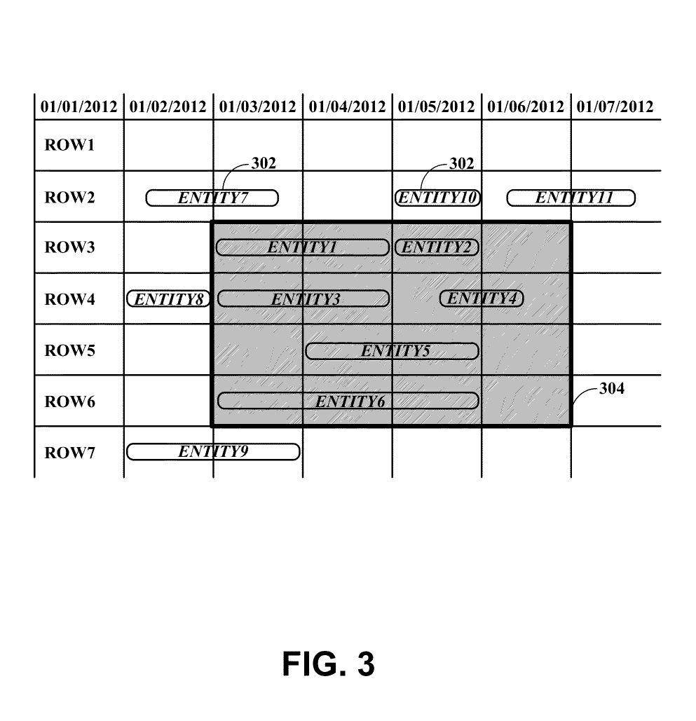

Referring now to FIG. 3, a diagram of an exemplary display of items 302 representing data entities in a rectangular multi-row selection calendar format is shown. In this instance, items representing data entities are shown in different rows and columns for the time periods they span. A user may designate a set of these items by tracing a rectangular trajectory 304 on the display, to interactively define row and column borders. The region designated may be highlighted as shown by shading and thickened border edges or by other known means. The items within the designated region are then identified, and the corresponding data entities may be selected by the user. Like the check-mark trajectory previously described, a rectangular trajectory 304 enables quick and efficient designation and selection of a set of items in a display. Any different gestures and resulting trajectories may be used for data entity selection, as long they are based on panning or touching gestures or other interactions performed using a finger or tactile device. For each, the embodiments calculate points in the trajectory and determine the intended data entities to be selected by detecting if a corresponding item 302 is crossed or surrounded by the trajectory 304. Thus, the embodiments work generically with substantially any type of approval gestures and may be used in any application where it is necessary to efficiently select single or multiple data entries for approval or any other subsequent processing.

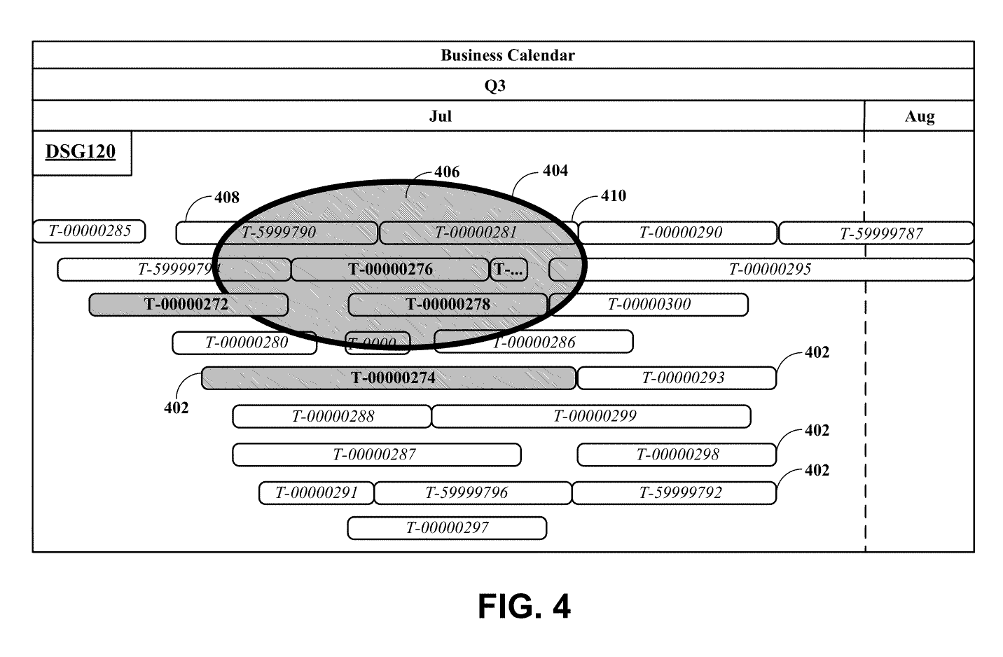

Referring now to FIG. 4, a diagram of an exemplary display of items 402 representing data entities in a calendar format with a boundary based selection is shown. In this case, items for the “DSG120” project are shown for July and August of a given year in a business calendar. Some items 402 have already been selected, as shown by font and shading in this example, as before. A user may trace a trajectory 404 on the graphical user interface using a tactile device or finger as previously described. In this case though, only those items fully contained within the boundaries of a region 406 defined by the trajectory 404 are selected. For example, items labeled T-5999790 and T-00000281 (items 408 and 410) are not fully within the set of points input by the user, and are therefore not selected. Items labeled T-00000276, T-00000278, and the item with the abbreviated label “T- . . . ” are fully within the region defined by the trajectory, and are selected. User preferences may however allow items only partially contained within the boundaries of the region to also be selected.

The boundary may be visually depicted in the display, at least temporarily, to help the user identify the limits of the region defined by the trajectory. The region 406 itself may be shaded, at least temporarily. User options may allow trajectory-based selection to accumulate selected items, or to toggle the selection status of items within the boundary. The display will then alter the depiction of selected items to denote their selection, for example by modifying the font and shading settings to those indicating selected items as described. Data entities corresponding to the selected items are added to a cache list used for subsequent processing of those items. Other region shapes, such as triangular, circular, or square for example, may also be used, and may be assigned particular interaction interpretations. Thus, the embodiments allow users to effectively select multiple entities across several groups using geometric shapes or trajectories, which may follow from gestures used naturally for selections.

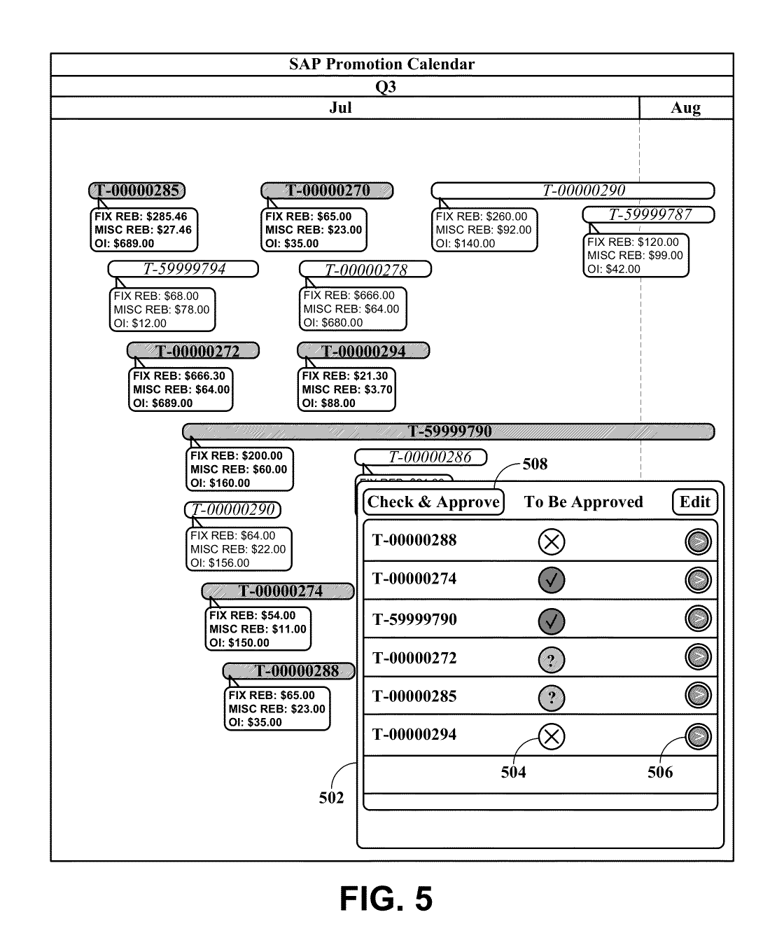

Referring now to FIG. 5, another exemplary display of items representing data entities in a calendar format with an approval status summary box is shown. In this instance, summary data for the data entries is provided below each item. An enhanced approval status summary box 502 is provided. The box may not only list items representing data entities selected for approval, but also provides an indicator 504 regarding predetermined business criteria, such as funds availability, for each entry. For example, items labeled T-00000288 and T-00000294 have been marked as not within predefined budget limits (with an X in this example), while items labeled T-00000274 and T-59999790 have been marked as being within predefined budget limits (with a check mark in this example). Items labeled T-00000272 and T-00000285 are of undetermined budget status, which may require further action to resolve.

Each item in the cache table of the approval status summary box may have a corresponding editing link 506 that may be used to trigger editing tools to attach notes to data entities. Such notes may include questions for a second user whose approval may also be required, or provide records of reasons behind an approval decision. The functionality of performing additional checks for funds availability may be incorporated with the approval process through use of the “Check & Approve” button 508. Thus the approval status summary box 502 facilitates quick and easy approval of multiple selected data entries.

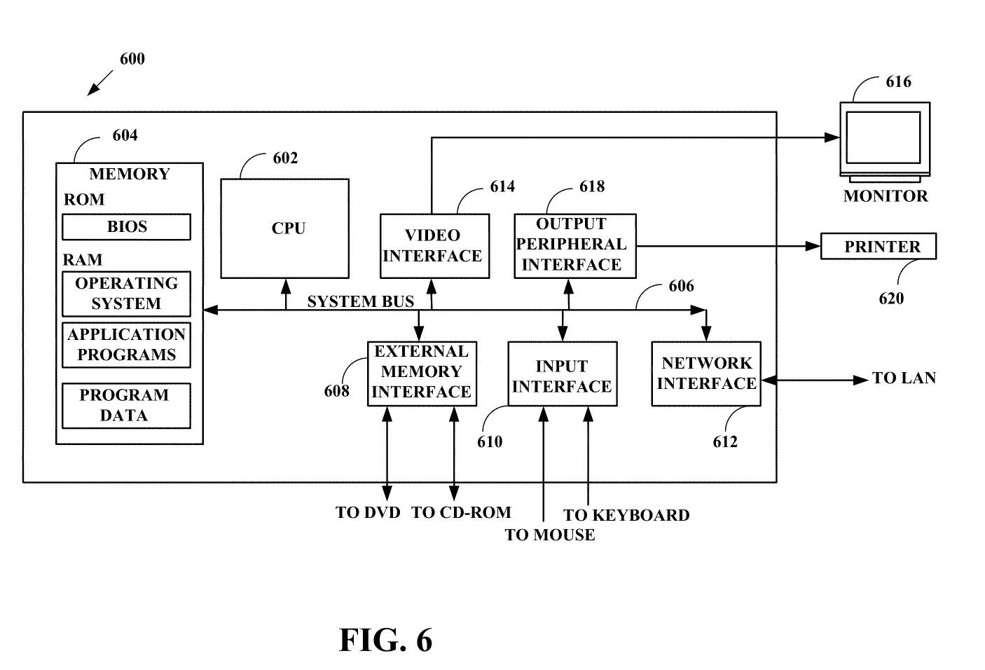

Referring now to FIG. 6, a computer system is depicted comprising an exemplary structure for implementation of the embodiments described above. Computer system 600 comprises a central processing unit (CPU) or processor 602 that processes data stored in memory 604 exchanged via system bus 606. Memory 604 may include read-only memory, such as a built-in operating system, and random-access memory, which may include an operating system, application programs, and program data. Computer system 600 may also comprise an external memory interface 608 to exchange data with a DVD or CD-ROM for example. Further, input interface 610 may serve to receive input from user input devices including but not limited to a keyboard, a mouse, or a touchscreen (not shown). Network interface 612 may allow external data exchange with a local area network (LAN) or other network, including the internet. Computer system 600 may also comprise a video interface 614 for displaying information to a user via a monitor 616 or a touchscreen (not shown). An output peripheral interface 618 may output computational results and other information to optional output devices including but not limited to a printer 620 for example via an infrared or other wireless link.

Computer system 600 may comprise a mobile computing device such as a personal digital assistant or smartphone for example, along with software products for performing computing tasks. The computer system of FIG. 6 may for example receive program instructions, whether from existing software products or from embodiments of the present invention, via a computer program product and/or a network link to an external site.

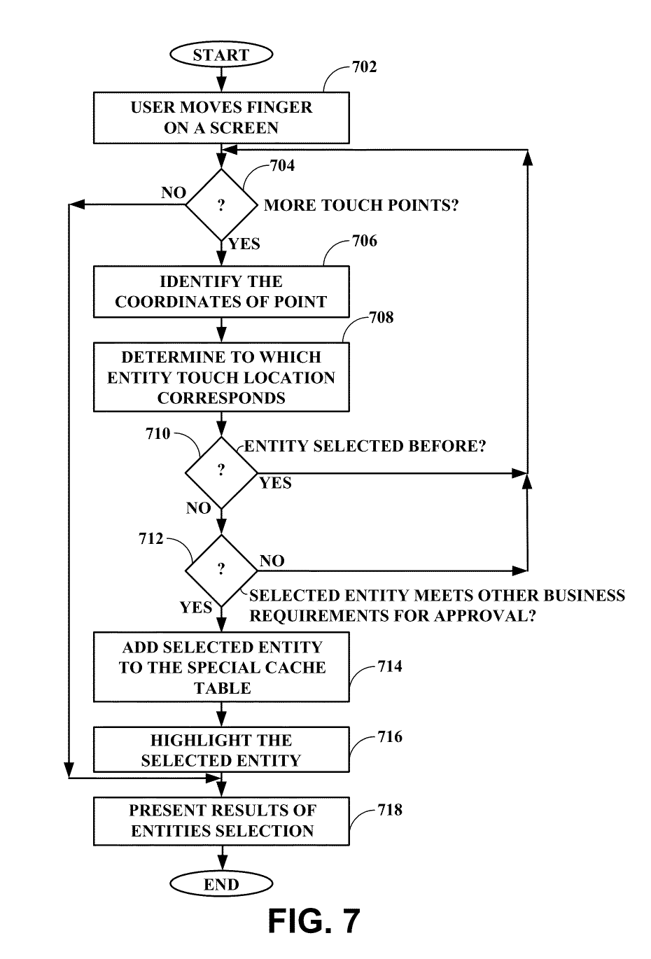

Referring now to FIG. 7, a flowchart of an exemplary method of operating the data entity selection scheme is shown. This method may be implemented by a processor executing instructions in a computer system, to be described, and the instructions may be tangibly embodied in a computer-readable medium or computer program product. The method execution begins at step 702 when a user moves a finger (or other pointing device) on a display screen. The display may for example include a touchscreen of a personal digital assistant, smartphone, or music playback device. The movement may be continuous or noncontinuous in the case where the user simply touches each item representing a data entity.

For each point detected during the movement, the method may perform the steps described below. The location(s) where the user has touched or passed with a finger (or stylus point) may be monitored essentially continuously by the processor, and a determination may be made at step 704 as to whether a single location has been designated by such interaction, or if more than one point forms a trajectory. If a single location has been designated by the user in a manner indicating a selection is desired (e.g. a double-click on a mouse or a double-tap with a stylus), execution of the method by the processor proceeds to present the results of the selection, for example by highlighting the selected item in the display.

If more than one point has been designated, the method execution processor proceeds at step 706 to identify the coordinates of each point in the trajectory being traced out by the user. The processor then determines at step 708 to which item and represented data entity the touched locations correspond. For example, if a check-mark trajectory is detected, the processor-driven method may identify which items were traversed in both a downward and an upward interaction direction. Other methods of determining data entity correspondence will be discussed below.

If the data entities are represented in a space with dates, the processor may identify what row and date corresponds to the touched location, and may compare the dates of data entities located in the row against the date of the touched location to determine if the touched location is within the date range of the data entity. If the data entries are not represented in a space with dates, the processor may perform a lookup in a cache table of entity locations to determine to which data entity the touched location belongs. The cache table may be populated when the data entities are initially placed into position.

If the data entity has been selected before, then processor execution may return in step 710 to tracking of designated points. Otherwise, the method may proceed in step 712 to determine if the selected data entity meets other requirements for approval. For example, if the approval status is not “approved” then the status may be set to “to be approved”. If not, then processor execution may return to tracking of designated points.

If the data entity is approved, the processor may add in step 714 the selected data entity to a special cache table of selected data entities. If the data entity appears in multiple groups, there is no need to record the same data entity multiple times. A hash table may be used to implement the special cache table, wherein the key of the cache table is the data entity ID. The value may be any other useful information that is to be preserved.

The processor then proceeds in step 716 to highlight the selected data entity by highlighting the corresponding item in the displayed graphical user interface when the interface is refreshed. The highlighting may include using particular fonts, colors, borders, and other graphical or animation effects as previously described. A user option may allow all item instances corresponding to the selected entity, including those appearing across multiple groups, to be selected and highlighted by the processor, for efficiency. The results of data entity/entities selection may then be presented by the processor in step 718, for example in an approval status summary box.

Details of the operations summarized in the flowchart are now described further. When the method determines data entity correspondence from an interaction trajectory, it may check whether items are surrounded by geometric regions of known shapes, such as rectangles, circles, ovals, triangles, etc. Items located only partially within regions may or may not be selected, according to predetermined user preferences. The method identifies the region boundaries and calculates the area occupied by the region. If the area is larger than the screen area (indicating panning), the method may determine what data entities are not included in the selected area; these data entities are not selected and thus should be excluded from the list of data entities displayed on the screen.

If the area of a region is less than or equal to the screen area, the method may use the region boundaries to determine the rows and columns delimiting the selected area. In a calendar format, columns typically correspond to the dates of the data entities. If beginning and ending dates of a range are determined, then data entities with dates located between those beginning and ending dates may be selected.

If no items are selected for approval, the method may instruct the processor to display a corresponding message to the user. Otherwise, the corresponding data entities may be depicted by the processor in an approval status summary box for easy user management. The user may remove a selected data entity from the list provided by the approval status summary box using the corresponding controls, and the removed data entity will accordingly not be highlighted in the graphical user interface. Similarly, the user may approve all selected entities with one click by using the corresponding controls. The approval status summary box may be dragged and scrolled within the display by the user, in order to view other data entities with the graphical user interface.

The method may further direct the processor to perform additional checks to verify whether a data entry meets particular business criteria, such as having sufficient available funds, before it is approved. An indicator in the approval status summary box may denote the outcome of such additional checks. Further, the method may direct the processor to allow users to view more details about a data entity by navigating to its details using for example an editing button to display and potentially modify all summary data.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While particular embodiments of the present invention have been described, it is to be understood that various different modifications within the scope and spirit of the invention are possible. The invention is limited only by the scope of the appended claims.

What is claimed is:

1. A computer-implemented method for selecting data entities, comprising:
displaying, in a graphical user interface, an item representing a data entity;
analyzing a graphical user interface input trajectory to detect user interaction with the item; and
selecting the data entity represented by the item.

2. The method of claim 1 wherein the graphical user interface is from at least one of a computer, a personal digital assistant, a smartphone, and a music playback device.

3. The method of claim 1 wherein the item comprises a graphical token.

4. The method of claim 1 wherein the data entity comprises at least one of a database entry, a project task, a document, a rebate for a promotional campaign, an assembly component, and a business transaction.

5. The method of claim 1 further comprising subjecting the selected data entity to subsequent processing, including at least one of expense approval, enterprise resource planning, and business related activities.

6. The method of claim 1 further comprising visually depicting data entity selection attributes by at least one of item font, item font size, item font color, item shading, item boundary line thickness, item colors, item blinking, item scrolling text, and item animation effects.

7. The method of claim 1 further comprising highlighting item instances representing each selected data entity upon data entity selection.

8. The method of claim 1 wherein at least one of a mouse, a trackball, a stylus, and a finger input the trajectory.

9. The method of claim 1 wherein the trajectory describes a geometrical region including at least one of a check mark, a rectangle, a circle, a triangle, an oval, and a square.

10. The method of claim 1 wherein repetition of the trajectory may perform at least one of selecting, de-selecting, and toggling item selection status.

11. The method of claim 1 further comprising displaying an approval status box with a list of selected data entities and at least one of a data entity approval control, a data entity deletion control, a data entity requirement indicator, and a data entity editing control.

12. The method of claim 1 wherein the analysis comprises:
detecting input user interface movements, and for each new input point detected:
determining if multiple input point locations comprise a trajectory, and responsively:
identifying coordinates of each input point in the trajectory;
determining to which items and represented data entities the input points correspond; and
adding each selected data entity to a cache table.

13. The method of claim 12 wherein the trajectory interacts with the item by at least one of crossing the item and surrounding the item within a geometric region.

14. The method of claim 12 further comprising visually highlighting item instances corresponding to each selected data entity.

15. A non-transitory computer readable medium storing instructions that, when executed by a processor, perform a method for selecting data entities, the method comprising:
displaying, in a graphical user interface, an item representing a data entity;
analyzing a graphical user interface input trajectory to detect user interaction with a displayed item; and
selecting a data entity represented by the item.

16. A system for selecting data entities, comprising:
a processor executing instructions to:
display, in a graphical user interface, an item representing a data entity;
analyze a graphical user interface input trajectory to detect user interaction with a displayed item; and
select a data entity represented by the item.

17. A system for selecting data entities, comprising:
means for displaying, in a graphical user interface, an item representing a data entity;
means for analyzing a graphical user interface input trajectory to detect user interaction with a displayed item; and
means for selecting a data entity represented by the item.

18. A computer-implemented method for selecting data entities, comprising:
displaying, in a graphical user interface, an item representing a data entity;
analyzing a graphical user interface input trajectory to detect user interaction with the item;
selecting the data entity represented by the item; and
highlighting item instances representing each selected data entity upon data entity selection,
wherein the trajectory interacts with the item by at least one of crossing the item and surrounding the item within a geometric region.
